(19) United States
(12) Patent Application Publication
(10) Pub. No.: US 2024/0288843 A1
(43) Pub. Date: Aug. 29, 2024

(54) Method for Determining an Operating Parameter of a Tool for Forming Components in a Press

(71) Applicant: Bayerische Motoren Werke Aktiiengesellschaft, Müenchen (DE)

(72) Inventor: Juergen HOFFMANN, Holzkirchen (DE)

(21) Appl. No.: 18/571,320

(22) PCT Filed: Aug. 2, 2022
(86) PCT No.: PCT/EP2022/071690

§ 371 Date: Dec. 18, 2023

(30) Foreign Application Priority Data
Aug. 25, 2021 (DE) 10 2021 121 991.4

(51) Int. Cl. G05B 19/18; B21C 51/00

(52) U.S. Cl. CPC G05B 19/182; B21C 51/00; G05B 2219/45152

(57) ABSTRACT

A method for determining an operating parameter of a tool for forming components in a press, comprising the steps of: gathering a semifinished product property for a specified number of blanks from a set comprising a plurality of blanks; ascertaining a mean of the semifinished product property for the specified number of blanks; selecting at least one blank, the semifinished product property of which lies in a specified interval around the mean, from the set; forming the selected blank by means of the tool in the press to produce the component, the tool being operated with the operating parameter; determining a deviation of the component shape of the component from a target value; and, adjusting or maintaining the at least one operating parameter in accordance with the determined deviation.

### BACKGROUND AND SUMMARY

This disclosure relates to a method for determining an operating parameter of a tool for forming components in a press.

Trial blanks with general specifications are ordered from a steel or aluminum supplier in order to work in a tool, for example a shaping tool, within the scope of toolmaking. The tool is worked-in using these trial blanks. What is found again and again in this case is that, when the tool or toolset is shifted from a tryout press within the scope of toolmaking to a series press, a component shape or component quality often no longer corresponds to the results originally obtained during the toolmaking. A very significant amount of time and/or work effort is spent on the series system in order to obtain the desired shaping result, and hence rectify the difference in the shaping result.

DE 10 2015 221 417 A1 shows how an individual identifier of singulated material parts can be linked with a respectively determined at least one part parameter.

It is an object of the present disclosure to provide a method for determining an operating parameter of a tool for forming components in a press, which particularly advantageously allows a tool change from a first press to a second, in particular from toolmaking to series production, to be able to be performed with particularly little effort.

The method according to the disclosure serves to determine an operating parameter of a tool for forming components in a press. In particular, the press can be embodied as a shaping press, with the result that the tool can be a shaping tool, for example. In the press, the component is formed, more particularly shaped, from a blank. The blank is in particular a metal sheet cut from a coil. The operating parameter is a parameter which for example describes or characterizes a state of the tool or a state of the press equipped with the tool while the component is formed. For example, if the tool comprises two tool halves, between which the blank is inserted for the purpose of forming the component, then the operating parameter can for example characterize the speed at which the two tool halves are closed, which is to say moved toward one another.

So that the operating parameter can now be determined particularly advantageously via the method, the method includes a plurality of steps.

In a first step, a semifinished product property is acquired for a given number of blanks from a set comprising a plurality of blanks. In other words, blanks are selected in accordance with the given number from a set of blanks, which contains a first number of blanks, and a semifinished product property, for example a sheet thickness, is acquired for each of these. In this case, the given number is less than or equal to the number of blanks in the set. By way of example, the acquisition can be implemented via a sensor. In addition or as an alternative, values of the semifinished product properties stored in a storage device can be retrieved within the scope of the acquisition.

In a second step of the method, a mean value of the semifinished product property is ascertained for the given number of blanks. In other words, a parameter for the trend of the distribution of the semifinished product property is ascertained over the blanks. In particular, the arithmetic mean can be determined or ascertained as the mean value.

In a third step of the method, at least one blank is selected from the set, wherein the at least one selected blank itself has a semifinished product property which is within a given interval about the mean value. In other words, the value of the semifinished product property of the selected blank has a certain distance from the mean value which is within a given interval. For example, the interval can be specified in percent in this case, with the result that the specific semifinished product property of the at least one selected blank deviates by no more than 10% from the mean value, for example. For example, multiples of the variant or standard deviations about the mean value also lend themselves to the interval.

Now, in a fourth step of the method, the selected blank is formed via the tool in the press to make the component, wherein the tool is operated with the operating parameter or, in particular, with a first value of the operating parameter. In other words, the at least one selected blank is formed, more particularly shaped, into the component using the press equipped with the workpiece. In this case, the operating parameter has a given value, which is advantageously chosen such that this can give rise to the expectation that a certain minimum component quality or component shape will be obtained or achieved when forming the component.

Thus, in a fifth step of the method, a deviation of the component shape of the component from a target value is determined. In other words, the shape accuracy of the component is verified, and hence a component quality is inferred. In this case, the component shape may also comprise, for example, a surface characteristic of the component in addition to the geometric size and dimension.

Finally, the at least one operating parameter is adjusted or kept in a sixth step of the method, depending on the determined deviation. In other words, an electronic computing device, for example, is used to ascertain whether a variation in the operating parameter can reduce a deviation of the component shape from the target value, with the result that, for example, a desired component quality can be obtained during forming by changing the operating parameter. It is possible in this case that the operating parameter was already specified in such a way that it no longer needs to be adjusted accordingly; thus there is, as it were, an adjustment or correction of the operating parameter by a value that tends to zero, with the result that the operating parameter is kept. The press can be both a tryout press and a series press.

An advantage arising from the method according to the disclosure is that it is possible to achieve a reduction of quality loops or tryout outlay by ensuring a blank quality in the press guaranteed by the method, in particular when trying out the tool. Moreover, it is possible to ascertain and obtain transparency or information about the material quality of the blanks. Moreover, it is for example possible to save costs by cutting the blanks used in the method in series coil systems rather than special systems, for example laser cutting systems.

Here, the disclosure is based on the insight that the trial blanks generally used these days within the scope of toolmaking do not have the same material properties as blanks subsequently used in series production. For example, the trial blanks come from a different manufacturer than the series blanks and therefore have different semifinished product properties or material properties. This may lead to problems since a process window for the material properties in currently used shaping tools, for example for body manufacture, is so small that only minor changes in the material properties may lead to rejection, despite these material properties still lying within a general specification for the blank. Alternatively, the given specification could be restricted further; however, this would lead to a significant price increase for the blanks, and this is undesirable. Moreover costly and/or time-consuming adjustments of the at least one process parameter or operating parameter of the tool must be implemented anew, for example when switching the tool from toolmaking to series production. Moreover, this may lead to relatively long downtimes of the press, which may entail further costs. These disadvantages can be avoided by the method according to the disclosure.

In this case, the respective semifinished product properties being acquired in each case for the individual blanks via sensors in coil systems for example, which is to say where the blanks are cut, can be used as an advantage. Thus, this lends itself to determining appropriate mean values, with the result that statements about the quality of the blanks for series production can also be ascertained. Thus, using the method according to the disclosure, there can be targeted selection of the blanks which meet or exceed the specifications. This is implemented by specifying the interval.

Now, the method allows a blank with the usual series quality to be selected such that, when forming the component, it is possible to exclude deviations on account of material differences which could occur during the use of a trial blank in toolmaking, and so the adjustment of the operating parameter, where necessary, is implemented in such a way that a fine adjustment can be carried out in a targeted manner for example, without for example the change or adjustment of the operating parameter being accompanied by an erroneous compensation of an incorrect correction on account of a blank that deviates from the specification.

Thus, as a rule, material, process, and quality data can likewise be acquired via suitable sensors in modern presses or, in particular, series presses. As a rule, these data can be used to increase the efficiency of the press, for example by virtue of combinations of material and process parameters which could lead to rejection being avoided when the press is in operation.

For example, this can be verified and determined via a model which is ascertained or calculated by an electronic computing device. Such a model can be used in the method according to the disclosure.

By acquiring the semifinished product properties, it is further possible to record the quality with which coils or blanks cut therefrom are provided by a supplier. Further, it is possible to infer the expected quality for a series production. In the method according to the disclosure, the material properties or semifinished product properties of a plurality of blanks are examined and compared, and blanks that do not meet the desired quality are excluded from the determination of the operating parameters which are required or advantageous for a tool for forming the component.

In this case, the method is in particular applied in such a way or the set of blanks is a set kept available for series production such that, for example, the method dispenses with specific trial blanks and, in the process, it is possible to ensure that the blanks used for trialing or determining the operating parameters in the toolmaking have the same quality as the blanks used during series production.

In an advantageous configuration of the disclosure, the operating parameter is a distance between tool halves of the tool, between which the respective blank is introduced for the purpose of forming the component. In other words, the method adjusts a distance between tool halves, in particular two tool halves, of the tool, wherein the distance is in particular a distance at which the tool halves with the blank inserted therebetween are already moved toward one another for forming purposes. An advantage arising as a result is that the distance advantageous for forming the component can be set in a particularly advantageous manner by the method.

In a further advantageous configuration of the disclosure, the operating parameter is a speed and/or a force, via which the tool halves are moved toward one another. In other words, the operating parameter describes the speed of the tool halves moving toward one another during the shaping process. In addition, or as an alternative, the operating parameter describes the force with which the tool halves are moved toward one another for forming the component from the blank. An advantage arising as a result is that the speed and/or the force can be ascertained and/or set or adjusted particularly advantageously by the method.

In a further advantageous configuration of the disclosure, the operating parameter describes an insertion position of the blank in the tool. In other words, the operating parameter characterizes a position adopted by the blank in the tool in order to subsequently be shaped into the component in the tool by pressing with the press. An advantage arising as a result is that an insertion position of the blank is ascertainable and/or adjustable in particularly advantageous fashion by the method.

In a further advantageous configuration of the disclosure, the semifinished product properties are acquired via at least one sensor when cutting or during the cutting and/or following a cutting of the blank from a coil. In other words, a coil system or a blank cutting system, for example, comprises a sensor designed to acquire the semifinished product property of the especially cut blank. For example, the semifinished product property is supplied to an electronic computing device, which performs the adjustment of the operating parameter for example. An advantage arising as a result is that, for example, the method can be integrated particularly advantageously in a series production or blanks for the series manufacture are used in the method.

In a further advantageous configuration of the disclosure, the operating parameter describes a shape of the tool. In other words, at least one tool half of the tool, for example, is adjusted in terms of its shape on account of the deviation of the component shape from a target shape. An advantage arising as a result is that a particularly advantageous component quality can be obtained by the method.

In a further advantageous configuration of the disclosure, the set of blanks is provided as blanks for a series production, with the result that the selected blank is a blank taken from series production. In other words, blanks from series production are always used, independently of whether the press used in the method or the tool used in the method is used in toolmaking or in series production. This can particularly advantageously avoid operating parameters being adjusted to deviations due to semifinished product properties that deviate from series manufacturing.

In a further advantageous configuration of the disclosure, a press that differs from a series press used for series production, in particular a press for toolmaking, is used as the press. In other words, a tool for subsequent series production is adjusted or the operating parameters for the tool are adjusted via the method outside of series production, in order to use the tool after toolmaking in an advantageous fashion and without a particular repetition of quality loops, which are performed approximately every six to eight weeks on a series press. An advantage arising as a result is that the operating parameter can be adjusted by the method in a particularly advantageous manner.

In a further advantageous configuration of the disclosure, the given number of blanks is equal to the number of blanks in the set. In other words, a semifinished product property is acquired for each of the blanks of the set of blanks, with the result that the mean value is ascertained over the semifinished product properties of all blanks. Hence, it is possible to select the at least one blank from the set of all blanks. An advantage arising as a result is that an interval about the mean value can be defined in a particularly advantageous manner, with the result that a specification for the blanks is particularly advantageously verifiable and/or the operating parameter can be adjusted particularly exactly.

In a further advantageous configuration of the disclosure, a further press with the tool and/or a further tool is operated via the method using the operating parameter. In other words, the operating parameters for the tool are determined or adjusted, and the tool can thereafter be accommodated in another press and used there with the appropriate operating parameter for forming the components. In addition or as an alternative, the operating parameter can likewise be ascertained for a tool, in particular a tool of the same design, by the method. An advantage arising as a result is that the method enables pivoting with the tool from toolmaking to series production.

Further features of the disclosure arise from the claims, the drawings and the description of the drawings. The features and feature combinations specified in the description above and the features and feature combinations specified below in the description of the drawings and/or shown on their own in the drawings are usable not only in the respectively specified combination, but also in other combinations, or on their own.

### BRIEF DESCRIPTION OF THE DRAWINGS

The disclosure will now be explained in detail on the basis of a preferred exemplary embodiment, with reference being made to the drawings, in which:

FIG. 1 shows a schematic flowchart of a method for determining an operating parameter of a tool for forming components in a press; and

FIG. 2 shows a schematic flowchart for planning a new component in toolmaking, which is intended to be formed via tools developed by toolmaking.

### DETAILED DESCRIPTION OF THE DRAWINGS

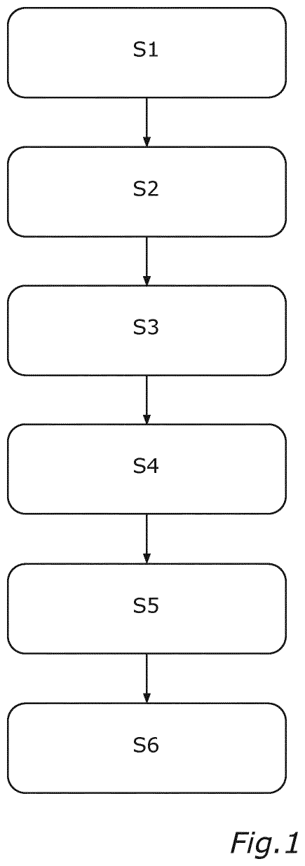

FIG. 1 shows a schematic perspective view of a method for determining an operating parameter of a tool for forming components in a press. In particular, the tool is a shaping tool, whereby the press is consequently formed as a shaping press. In particular, the tool may comprise two tool halves, between which a blank is inserted or insertable and can be shaped into the component by the two tool halves in the press moving toward one another.

In so doing, it is known that current manufacturing tolerances for components embodied as body components or outer skin components for motor vehicles can only be small, as minor changes in the material properties or semifinished product properties of the blanks, from which the components are formed, may lead to rejects when forming the components.

In order to avoid such rejects, and moreover, for example, configure the retrofitting of a press with a new tool to take up as little time as possible, a method comprising a plurality of steps is proposed.

In a first step S1, the semifinished product property is acquired for a given number of blanks from a set comprising a plurality of blanks. In this case, the number of blanks is less than or equal to the number of blanks in the set.

In a second step S2 of the method, a mean value of the semifinished product properties is ascertained for the given number of blanks.

In a third step S3 of the method, at least one blank whose semifinished product property is within a given interval about the mean value is selected from the set.

In a fourth step S4 of the method, the selected blank is formed via the tool in the press to make the component, wherein the tool is operated with the operating parameter or the press is operated with the operating parameter for the tool.

In a fifth step S5 of the method, a deviation of the component shape of the component, formed by the press using the operating parameter, from a target value is determined.

Finally, in a sixth step S6 of the method, the at least one operating parameter is adjusted or kept depending on the determined deviation.

The semifinished product property is advantageously acquired using at least one sensor during and/or after the respective blank is cut from a coil. Thus, coil machines or blank cutting machines can advantageously be equipped with sensors these days, via which the semifinished product property for the respectively cut blank or blank to be cut is acquired and, for example, stored in the storage device of an electronic computing device, which for example, selects the at least one blank. In this case, the given number of blanks advantageously equals the number of blanks in the set, with the result that the mean value of the semifinished product property, for example, can be acquired particularly precisely for the greatest possible number of blanks, or for all of the blanks, used in the method. In this case, the set of blanks is provided for a series production. In other words, the blanks used in the method are the blanks used in the press and/or in further presses during a series production of the components, with the result that the at least one blank selected by the method is a blank taken from series production.

The press used in the method is a tryout press in toolmaking in particular, in which for example the tool for a new component or a new type of the component is worked-in or set. Thus, the press used in the method is advantageously a press that differs from a series press for series production. Alternatively, the press used in the method may also be a press used in series production. Further, the method can be performed using the operating parameter in a further press with the tool and/or a further tool, or a further press is operated with the operating parameter ascertained by the method.

If the component is a fender for example, multi-stage tools are generally used. For example, a shell can be drawn from the sheet or the blank in a first forming process. In a second stage, excess material is cut away using the tool, for example. In a third stage, flanges can be formed at the corners. In a fourth stage, holes required in the fender can be formed in the component or introduced into the component, for example. In this case, a dedicated press is normally used for each stage in series production, and the component or the blank is moved between the individual presses, for example via a robotic arm.

By way of the method, a corresponding operating parameter can be adjusted for each stage, even for a multi-stage tool.

The presented method allows blanks from series manufacturing rather than special trial blanks to be used within the scope of toolmaking in a tryout press, in particular in the press used in the method.

A distance between the tool halves of the tool, in particular in the driven together tool, can be set or adjusted as the operating parameter. In addition or as an alternative, the operating parameter can adjust a speed and/or a force, via which the tool halves are moved toward one another.

In addition or as an alternative, a position of the blank in the tool can be set as the operating parameter. Moreover, the operating parameter can describe a shape of the tool itself.

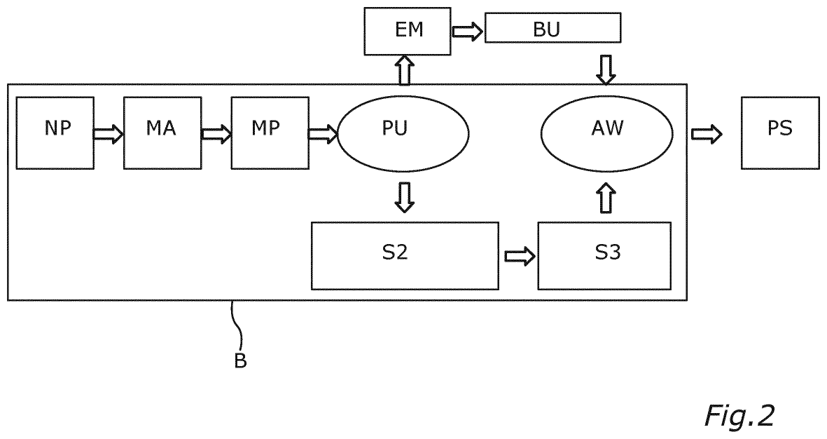

FIG. 2 shows a schematic flowchart for a possible development process of a tool for a new component or the development process of the component in toolmaking. Implemented first is the new part planning NP, within the scope of which an external impression of the component to be newly created is ascertained, for example. Subsequently, there is a material request MA, in which the availability of specific blanks and specific semifinished product properties is ascertained, for example. This is followed by material planning MP. Subsequently, there can be a test PÜ in a tool in toolmaking, which sources an availability of the required materials ascertained during the material planning.

Until now, as shown in FIG. 2, the conventional path was to have an external material procurement EM; that is to say a separate blank, a so-called universal blank, was for example ordered from a supplier who provides coils for series production, the said universal blank subsequently being provided by an external vendor. Thus, the box BU shows the provision of the universal blank. The universal blank is subsequently supplied within the scope of toolmaking, and AW represents the delivery within the scope of toolmaking. Following delivery within the scope of toolmaking and depending on the shape of the component to be newly created or depending on the shape of the tool, the universal blank must be cut, for example by laser cutting, by an external service provider in particular. Thus, a further work step PS, the cutting of the blank, is required, which can be dispensed with by the method presented here. The external material procurement EM is now dispensed with in the method; instead, the semifinished product property or its mean value is ascertained in step S2, and subsequently there is a provision of the blank on the basis of the selection in step S3. Thus, as indicated by the box B in FIG. 2, the entire tool development, for example, can be performed particularly advantageously without external service providers. Thus, the presented method results in a reduction in the tryout outlay of the tryout phase when providing a new tool for the press, wherein the new tool should form a newly developed component in particular. This happens as a result of ensuring an unchanging blank quality via the method. Moreover, it is possible to obtain monitoring of the semifinished product properties and hence the material quality of the blanks. Moreover, costs can be saved, for example, because external steps EM and BU are dispensed with.

By way of the presented method, it is particularly advantageously possible to use material data from the series operation for the tool tryout within the scope of toolmaking.

### LIST OF REFERENCE SIGNS

S1 First step
S2 Second step
S3 Third step
S4 Fourth step
S5 Fifth step
S6 Sixth step
MP Material planning
MA Material request
MP Material planning
PÜ Test
EM External material procurement
BU Provision of a universal blank
AW Delivery within the scope of toolmaking
PS Blank cutting
B Box

1.-10. (canceled)

11. A method for determining an operating parameter of a tool for forming components in a press, including the following steps:
acquiring a semifinished product property for a given number of blanks from a set comprising a plurality of blanks;
ascertaining a mean value of the semifinished product property for the given number of blanks;
selecting at least one blank, the semifinished product property of which is within a given interval about the mean value, from the set;
forming the selected blank via the tool in the press to make the component, with the tool being operated with the operating parameter;
determining a deviation of the component shape of the component from a target value; and,
adjusting or keeping the at least one operating parameter depending on the determined deviation.

12. The method according to claim 11,
wherein the operating parameter is a distance between tool halves of the tool, between which the respective blank is introduced for the purpose of forming the component.

13. The method according to claim 12,
wherein the operating parameter is a speed and/or force, by means of which the tool halves are moved toward one another.

14. The method according to claim 11,
wherein the operating parameter describes an insertion position of the blank in the tool.

15. The method according to claim 11,
wherein the semifinished product property is acquired by at least one sensor during a cutting and/or following the cutting of the respective blank from a coil.

16. The method according to claim 11,
wherein the operating parameter describes a shape of the tool.

17. The method according to claim 11,
wherein the set of blanks are provided as blanks for a series production, with the result that the selected blank is a blank taken from series production.

18. The method according to claim 17,
wherein a press that differs from a series press used for series production is used as the press.

19. The method according to claim 11,
wherein the given number of blanks is equal to the number of blanks in the set.

20. The method according to claim 11,
wherein a further press with the tool and/or a further tool is operated using the operating parameter.
